(19) United States
(12) Patent Application Publication
(10) Pub. No.: US 2007/0126329 A1
(43) Pub. Date: Jun. 7, 2007

(54) BRIGHTNESS ENHANCEMENT FILM AND BACKLIGHT MODULE

(75) Inventors: Fu-Ming Chuang, Hsinchu (TW); Yi-Tien Lu, Hsinchu (TW); Bih-Chang Wang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: YOUNG OPTICS INC., Hsinchu (TW)

(21) Appl. No.: 11/549,124

(22) Filed: Oct. 13, 2006

(30) Foreign Application Priority Data
Nov. 21, 2005 (TW) 94140765

(51) Int. Cl. H01K 1/30; H01J 5/16; H01J 61/40

(52) U.S. Cl. 313/110; 313/113

(57) ABSTRACT

A brightness enhancement film having a light exit surface and multiple stripe prisms disposed opposite to the light exit surface is provided. The stripe prisms are parallel, each stripe prism has a light incident curved surface, a light reflective inclined surface and a flat surface, and the light incident curved surface is connected between the light reflective inclined surface and the flat surface. The light incident curved surface and the flat surface are opposite to the light reflective inclined surface. The light incident curved surface is an outward curved surface. Further, a light beam from the light incident curved surface is reflected to the light exit surface by the light reflective surface.

### CROSS-REFERENCE TO RELATED APPLICATION

This application claims the priority benefit of Taiwan application serial no. 94140765, filed on Nov. 21, 2005. All disclosure of the Taiwan application is incorporated herein by reference.

### BACKGROUND OF THE INVENTION

1. Field of the Invention

The present invention relates to an optical device. More particularly, the present invention relates to a brightness enhancement film (BEF) and a backlight module having the brightness enhancement film.

2. Description of Related Art

FIG. 1 is a schematic diagram of a conventional backlight module. FIG. 2A is a three-dimensional diagram of the two brightness enhancement films in FIG. 1, and FIG. 2B is a schematic diagram of the light path of the light beam in brightness enhancement film. Referring to FIG. 1, FIG. 2A and FIG. 2B, the conventional backlight module 100 includes a light source 110, a light guide plate 120, two diffusion films 130a, 130b, two brightness enhancement films 140a, 140b and a reflective film 150. The light guide plate 120 is disposed aside of the light source 110, and the diffusion films 130a, 130b and the brightness enhancement films 140a, 140b are disposed above the light exit surface 122 of the light guide plate 120, and the brightness enhancement films 140a, 140b are disposed between the diffusion films 130a, 130b.

In the above mentioned backlight module 100, a light beam 112 emitted by the light source 110 may pass through the diffusion film 130a, the brightness enhancement films 140a,140b, and the diffusion film 130b in sequence after exiting from a light exit surface 122 of the light guide plate 120. And, a direction of the light beam 112 after passing the diffusion film 130b is parallel to Z axis. The brightness enhancement film 140a is suitable for concentrating the light beam in Y-Z plane direction, and the brightness enhancement film 140b is suitable for concentrating the light beam in X-Z plane direction.

In the conventional art, two brightness enhancement films 140a, 140b are required to focus the light beams in both Y-Z plane direction and X-Z plane direction, and thus the fabrication cost of the backlight module 100 is high, and the backlight module 100 is thick. In addition, as part of the light beam (for example, the light beam 112′) is totally reflected in the brightness enhancement films 140a, 140b and radiates into the light guide plate 120, the brightness of the backlight source provided by the backlight module 100 may be reduced.

### SUMMARY OF THE INVENTION

Accordingly, the present invention is directed to a brightness enhancement film capable of improving the brightness enhancement effect.

The present invention is also directed to a backlight module with lower fabrication cost.

In accordance with the above and other aspects of the present invention, a brightness enhancement film, including a light exit surface and multiple stripe prisms disposed opposite to the light exit surface is provided. The stripe prisms are arranged substantially parallel, Each stripe prism has a light incident curved surface and a light reflective inclined surface and the light incident curved surface is opposite to the light reflective inclined surface and the light incident curved surface is an outward curved surface. Furthermore, the light reflective inclined surface is suitable for reflecting a light beam from the light incident curved surface, so that a direction of the light beam after being reflected is approximately parallel to a normal direction of the light exit surface and the light beam emitted from the light exit surface.

In one embodiment of the present invention, each of the stripe prisms mentioned above further includes a flat surface, and the light incident curved surface of each stripe prism is connected between the light reflective inclined surface and the flat surface.

In one embodiment of the present invention, the acute angle between the light reflective inclined surface and the light exit surface of each stripe prism is, for example, between 50 degrees and 67.5 degrees.

In one embodiment of the present invention, the maximum width of each stripe prism is P, and the radius of curvature of each light incident curved surface is R, and 1.3≦P/R≦2.

In one embodiment of the present invention, the thickness of each stripe prism is H, and the radius of curvature of each light incident curved surface is R, and 1.3≦H/R≦1.7.

In one embodiment of the present invention, the brightness enhancement film further includes multiple nano-size microstructures disposed on the light exit surface.

In one embodiment of the present invention, the brightness enhancement film further includes multiple cylinder lenses disposed on the light exit surface, and are arranged substantially parallel to each other.

In one embodiment of the present invention, the stripe prisms are arranged parallel along a first direction, and the cylinder lenses are arranged parallel along a second direction, the first direction is perpendicular to the second direction.

In one embodiment of the present invention, the cylinder lenses are substantially semi-cylinder lenses.

The present invention further provides a backlight module including a light source, a light guide plate and the brightness enhancement film. The light guide plate is disposed aside of the light source, and the brightness enhancement film is disposed at one side of the light guide plate. The light source is suitable for emitting a light beam, and the light beam is suitable to radiate into the brightness enhancement film via the light guide plate.

In one embodiment of the present invention, the backlight module further includes a diffusion film, disposed above the brightness enhancement film.

In one embodiment of the present invention, as the light incident curved surface of the cylinder prism has better light concentration effect, the brightness enhancement effect of the brightness enhancement film can be improved. In addition, the backlight module of the present invention includes only one brightness enhancement film, therefore, not only the fabrication cost can be reduced, but also the thickness of the backlight module can be reduced.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional backlight module.

FIG. 2A is a three-dimensional diagram of the two brightness enhancement films in FIG. 1.

FIG. 2B is a schematic diagram of the light path of the light beam in a conventional brightness enhancement film.

FIG. 3 is a schematic diagram of a backlight module according to one embodiment of the present invention.

FIG. 4 is a three-dimensional diagram of the brightness enhancement film in FIG. 3.

FIG. 5 is a schematic diagram of the light path of the light beam in a stripe prism of the present invention.

FIG. 6 is a relationship diagram of a view angle and a light intensity of the light beam after emitting from a brightness enhancement film according to the present invention.

FIG. 7 is a schematic diagram of a brightness enhancement film according to another embodiment of the present invention.

FIG. 8 is an enlarged diagram of the nano-size microstructure in FIG. 7.

FIG. 9 is a schematic diagram of the light path for transmitting the light beam to the light exit surface with micro-structure and the light exit surface without micro-structure in the same angle.

FIG. 10 is a schematic diagram of a brightness enhancement film according to another embodiment of the present invention.

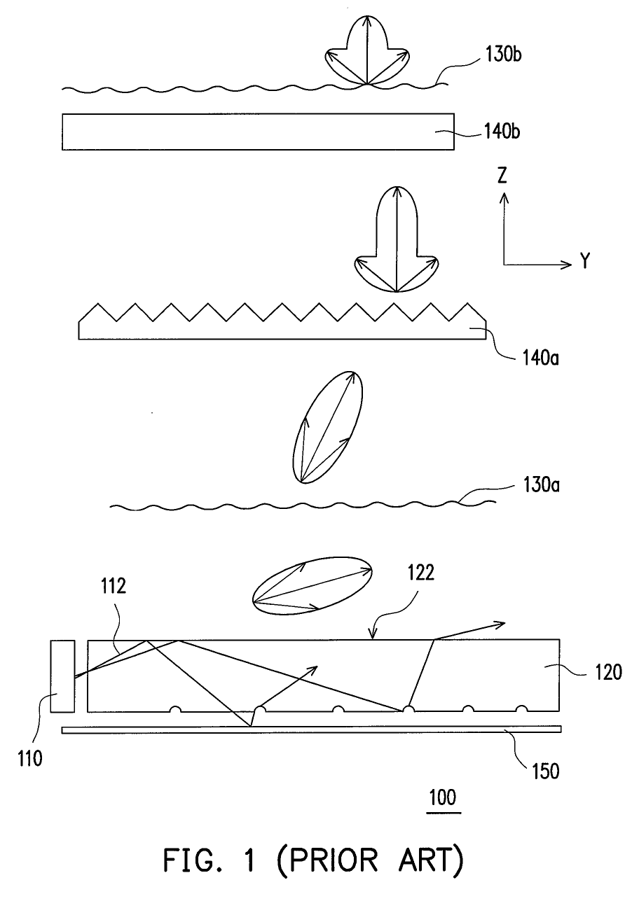

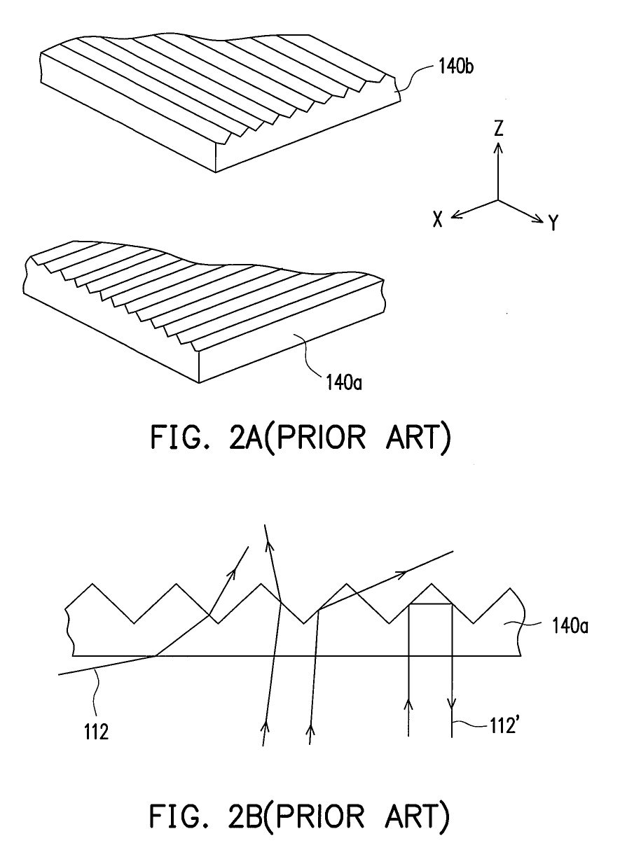

### DESCRIPTION OF EMBODIMENTS

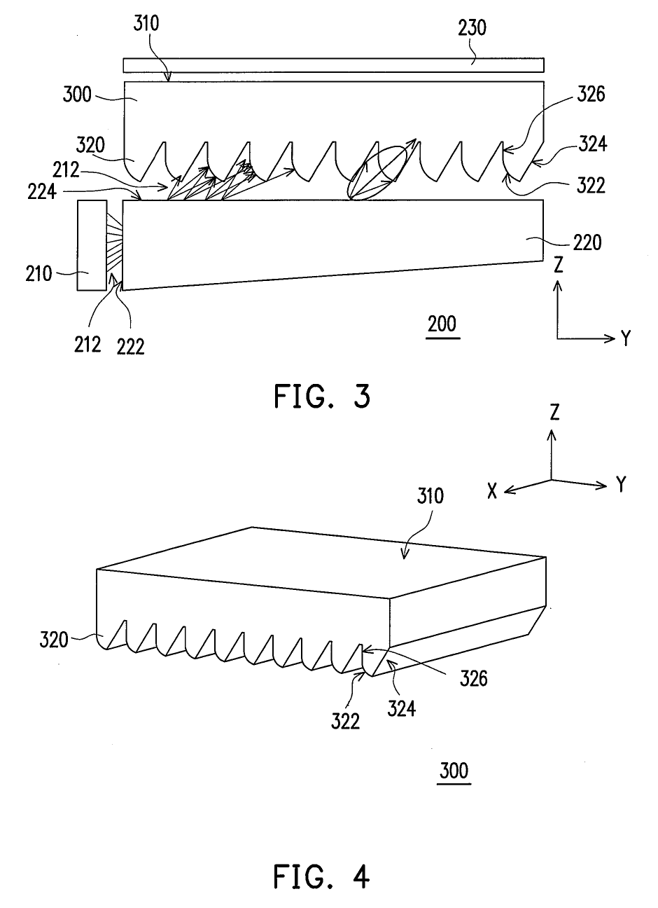

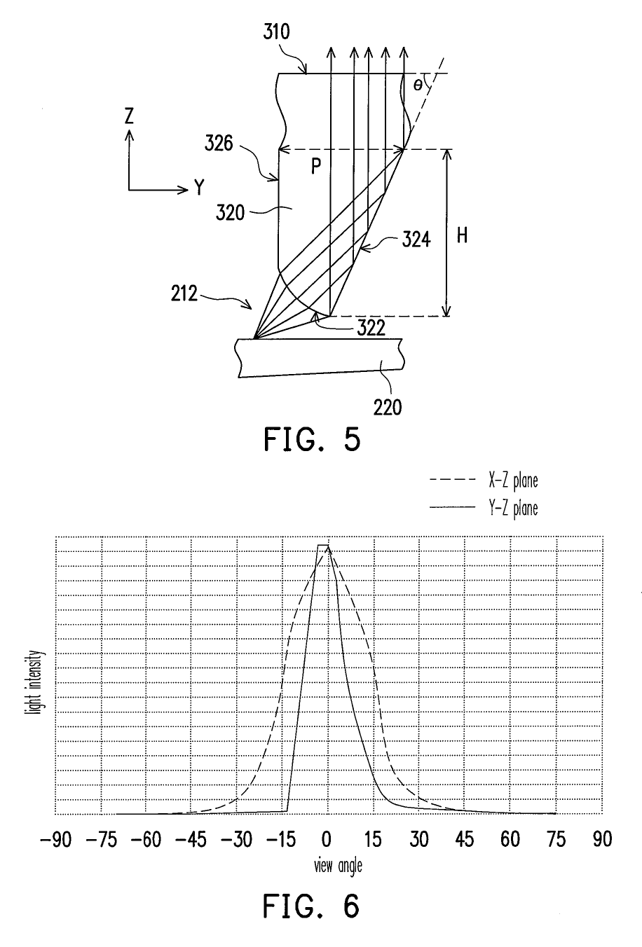

FIG. 3 is a schematic diagram of a backlight module according to one embodiment of the present invention; FIG. 4 is a tri-dimensional diagram of the brightness enhancement film in FIG. 3; and FIG. 5 is a schematic diagram of the light path of the light beam in a stripe prism. Referring to FIG. 3 to FIG. 5, the backlight module 200 in the embodiment of the present invention includes a light source 210, a light guide plate 220 and a brightness enhancement film 300. The light guide plate 220 is disposed aside of the light source 210, and the brightness enhancement film 300 is disposed at one side of the light guide plate 220. The brightness enhancement film 300 has a light exit surface 310 and multiple stripe prisms 320 disposed opposite to the light exit surface 310, and the stripe prisms 320 are arranged substantially parallel to each other. In addition, each stripe prism 320 has a light incident curved surface 322 and a light reflective inclined surface 324. The light incident curved surface 322 is opposite to the light reflective inclined surface 324, and the light incident curved surface 322 is an outward curved surface.

In one preferred embodiment of the present invention, each stripe prism 320 further includes a flat surface 326, and the light incident curved surface 322 of each stripe prism 320 is connected between the light reflective inclined surface 324 and the flat surface 326. Moreover, the acute angle θ between the light reflective inclined surface 324 and the light exit surface 310 of each stripe prism 320 is between 50 degrees and 67.5 degrees. The ratio of the maximum width P of the stripe prism 320 and the radius of curvature R of the light incident surface 322 is, for example, 1.3-2, that is, 1.3≦P/R≦2. In addition, the ratio of the thickness H of the stripe prism 320 and the radius of curvature R of the light incident surface 322 is between 1.3-1.7, that is, 1.3≦H/R≦1.7.

In the abovementioned backlight module 200, the light source 210 may be a cold cathode fluorescence lamp, light emitting diode or any other suitable light source suitable to emit a light beam 212. The incident light beam 212 from the light incident surface 222 of the light guide plate 220 may transmit through the light emitting surface 224, and then radiate into the brightness enhancement film 300 from the light incident curved surfaces 322 of the stripe prisms 320. Thereafter, the light beam 212 may be totally reflected from the light reflective inclined surfaces 324 of the stripe prisms 320 and exit from the light exit surface 310. The light incident curved surfaces 322 can focus the light beam 212 both in X-Z plane direction and Y-Z plane direction, and a direction of the light beam 212 after totally reflected from the light reflective inclined surfaces 324 is proximately parallel to Z axis, the Z axis in the embodiment is a normal direction of the light exit surface 310. In addition, in order to further improve the quality of the backlight source provided by the backlight module 200, a diffusion film 230 may be disposed above the brightness enhancement film 300.

FIG. 6 is a relationship diagram of a view angle and a light intensity of the light beam after emitting from a brightness enhancement film according to the present invention. Referring to FIG. 5 and FIG. 6, it can be inferred from FIG. 6 that, after the light beam 212 from the light guide plate 220 passes through the brightness enhancement film 300, the view angle on the X-Z plane is between −16 degrees and 16 degrees, while the view angle on the Y-Z plane is between −8 degrees and 8 degrees. In addition, all of the view angles corresponding to the positions of the strongest light intensity are about 0 degree, that is, the locations of the strongest light beam are all at the normal direction of the light exit surface 310 (i.e., the direction of Z axis). Therefore, the brightness enhancement film 300 may improve the central brilliance of the backlight source provided by the entire backlight module 200.

Compared with the conventional art, the backlight module 200 in the embodiment includes only one brightness enhancement film 300 for focusing the light beam 212 in both X-Z plane direction and Y-Z plane direction, so that the cost of the brightness enhancement film can be reduced, and thereby reduce the cost of the backlight module 200. In addition, as the backlight module 200 has only one brightness enhancement film 300, therefore the thickness of the backlight module 200 is reduced.

It should be noted that, the embodiment shown in FIG. 6 is used as an example, and is not intended to limit the scope of the present invention. Actually, the relationship of the view angle and the light intensity of the emitted light beam 212 from the brightness enhancement film 300 of the present invention may be slightly different due to the difference in the maximum width P, the thickness H and the radius of the curvature R of the light incident curved surface 322 or other aspects.

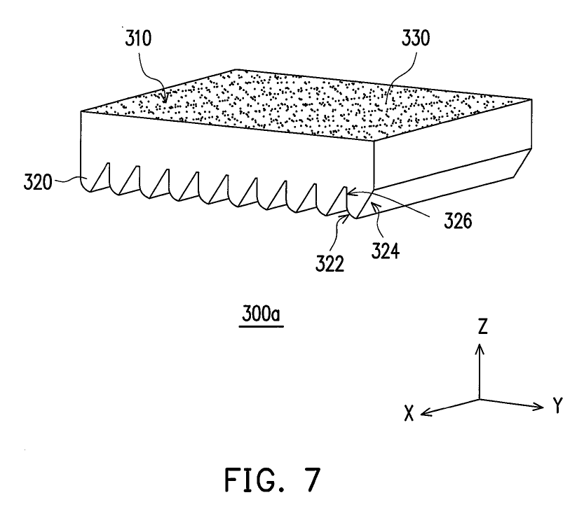

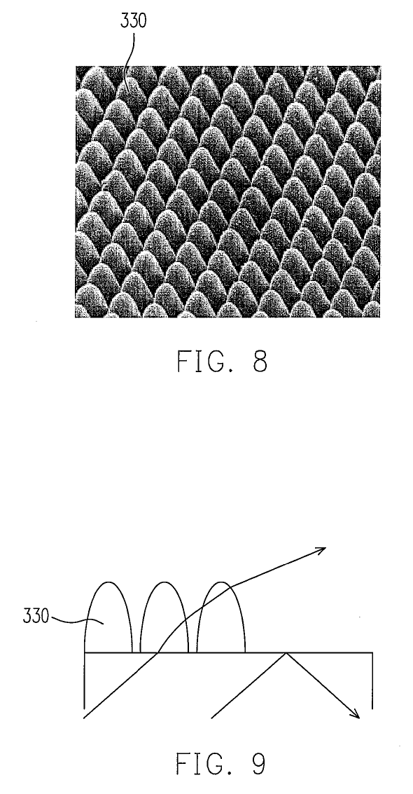

FIG. 7 is a schematic diagram of a brightness enhancement film according to another embodiment of the present invention. Referring to FIG. 7, the brightness enhancement film 300a in this embodiment is similar to the brightness enhancement film 300 shown in FIG. 4 except for a plurality of nano-size microstructures 330 disposed on the light exit surface 310. The nano-size microstructures 330 are, for example, microstructures such as small protruding balls, circle balls, pyramidal structures, and the like. Referring to FIG. 8, the size of the microstructure is about hundreds of nanometers. The nano-size microstructures 330 may polarize the incident light beam, which may cause the light exit surface 310 to have antireflective function. Referring to FIG. 9, the transmissivity of light beam in the light exit surface 310 can be improved, and furthermore, the light emitting efficiency of the brightness enhancement film 330a can be improved.

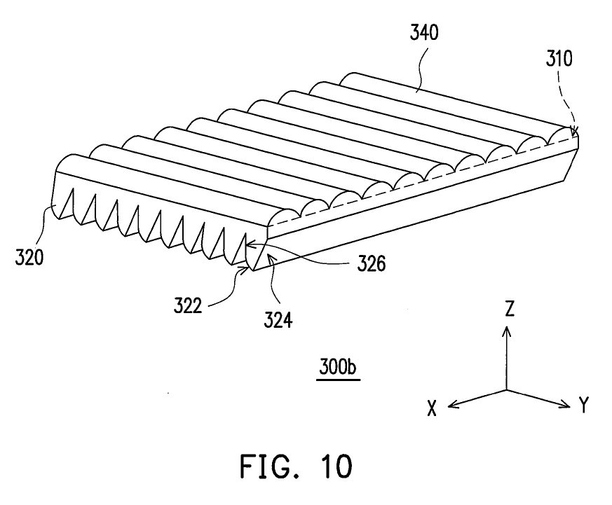

FIG. 10 is a schematic diagram of a brightness enhancement film according to another embodiment of the present invention. Referring to FIG. 10, the brightness enhancement film 300b in this embodiment is similar to the brightness enhancement film 300 (as shown in FIG. 4) except that the brightness enhancement film 300b further includes a plurality of cylinder lenses 340. The cylinder lenses 340 are arranged parallel to each other and are disposed on the light exit surface 310. The stripe prisms 320 are, for example, arranged in parallel and are along a first direction (Y axis), and the cylinder lenses 340 are arranged in parallel and are along a second direction (X axis), the first direction is perpendicular to the second direction.

The abovementioned cylinder lenses 340 are, for example, semi-cylinder lenses, and the cylinder lenses 340 are parallel and arranged on the light exit surface 310 along X axis, therefore, the cylinder lenses 340 can further focus the light beam in X-Z plane direction to further centralize the light beam, and the brightness enhancement effect of the brightness enhancement film 300b can be improved.

In summary, the brightness enhancement film and backlight module of the present invention have at least the following advantages.

First, as the light incident curved surface of the cylinder lenses can focus the light beam both in X-Z plane direction and Y-Z plane direction, the brightness enhancement film of the present invention has better brightness enhancement effect so as to improve the central brilliance of the backlight source provided by the backlight module.

Second, compared with the conventional art, the backlight module of the present invention includes only one brightness enhancement film for focusing the light beam in both X-Z plane direction and Y-Z plane direction, therefore, not only the fabrication cost can be reduced, but also the thickness of the backlight module can be reduced.

Third, in one embodiment, nano-size microstructures can be disposed on the light exit surface of the brightness enhancement film so as to improve the light emitting efficiency of the brightness enhancement film.

In one embodiment, cylinder lenses can be disposed on the light exit surface of the brightness enhancement film so as to further improve the brightness enhancement effect of the brightness enhancement film.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A brightness enhancement film, comprising a light exit surface and multiple stripe prisms disposed opposite to the light exit surface, and the stripe prisms arranged substantially parallel to each other, each stripe prism comprising a light incident curved surface and a light reflective inclined surface, the light incident curved surface opposite to the light reflective inclined surface and the light incident curved surface including an outward curved surface, the light reflective inclined surface being suitable to reflect a light beam from the light incident curved surface, a direction of the light beam after being reflected is approximately parallel to a normal direction of the light exit surface and the light beam exiting from the light exit surface.

2. The brightness enhancement film as claimed in claim 1, wherein each stripe prism further comprises a flat surface, and the light incident curved surface of each stripe prism is connected between the light reflective inclined surface and the flat surface.

3. The brightness enhancement film as claimed in claim 1, wherein an acute angle between the light reflective inclined surface and the light exit surface of each stripe prism is from 50 degrees to 67.5 degrees.

4. The brightness enhancement film as claimed in claim 1, wherein a maximum width of each stripe prism is P, and a radius of curvature of each light incident curved surface is R, and 1.3≦P/R≦2.

5. The brightness enhancement film as claimed in claim 1, wherein a thickness of each stripe prism is H, and a radius of curvature of each light incident curved surface is R, and 1.3≦H/R≦1.7.

6. The brightness enhancement film as claimed in claim 1, further comprising a plurality of nano-size microstructures disposed on the light exit surface.

7. The brightness enhancement film as claimed in claim 1, further comprising a plurality of cylinder lenses disposed on the light exit surface, and, the cylinder lenses are arranged substantially parallel to each other.

8. The brightness enhancement film as claimed in claim 7, wherein the stripe prisms are arranged parallel and are along a first direction, and the cylinder lenses are arranged parallel and are along a second direction, the first direction is perpendicular to the second direction.

9. The brightness enhancement film as claimed in claim 7, wherein the cylinder lenses are semi-cylinder lenses.

10. A backlight module, comprising:
a light source, suitable for providing a light beam;
a light guide plate, disposed aside of the light source; and
a brightness enhancement film, disposed at one side of the light guide plate, wherein the light beam is suitable to radiate into the brightness enhancement film via the light guide plate, and the brightness enhancement film has a light exit surface and multiple stripe prisms disposed opposite to the light exit surface, and the stripe prisms are arranged substantially parallel to each other, each stripe prism has a light incident curved surface and a light reflective inclined surface, the light incident curved surface is opposite to the light reflective inclined surface and the light incident curved surface is an outward curved surface, and wherein the light reflective inclined surface is suitable to reflect the light beam from the light incident curved surface, so that the light beam exits from the light exit surface.

11. The backlight module as claimed in claim 10, wherein each stripe prism further comprises a flat surface, and the light incident curved surface of each stripe prism is connected between the light reflective inclined surface and the flat surface.

12. The backlight module as claimed in claim 10, wherein an acute angle between the light reflective inclined surface and the light exit surface of each stripe prism is from 50 degrees to 67.5 degrees.

13. The backlight module as claimed in claim 10, wherein a maximum width of each stripe prism is P, and a radius of curvature of each light incident curved surface is R, and 1.3≦P/R≦2.

14. The backlight module as claimed in claim 10, wherein a thickness of each stripe prism is H, and a radius of curvature of each light incident curved surface is R, and 1.3≦H/R≦1.7.

15. The backlight module as claimed in claim 10, wherein the brightness enhancement film further comprises a plurality of nano-size microstructures disposed on the light exit surface.

16. The backlight module as claimed in claim 10, wherein the brightness enhancement film further comprises a plurality of cylinder lenses disposed on the light exit surface, and the cylinder lenses are substantially parallel to each other.

17. The backlight module as claimed in claim 16, wherein the stripe prisms are arranged parallel and are along a first direction, and the cylinder lenses are arranged parallel and are along a second direction, the first direction is perpendicular to the second direction.

18. The backlight module as claimed in claim 16, wherein the cylinder lenses are semi-cylinder lenses.

19. The backlight module as claimed in claim 10, further comprising a diffusion film disposed above the brightness enhancement film.

20. The backlight module as claimed in claim 10, wherein a direction of the light beam reflected from the light reflective inclined surface is approximately parallel to a normal direction of the light exit surface.
